(19) United States
(12) Patent Application Publication
(10) Pub. No.: US 2023/0124473 A1
(43) Pub. Date: Apr. 20, 2023

(54) IMAGE PROCESSING DEVICE AND IMAGE PROCESSING METHOD

(71) Applicant: SONY GROUP CORPORATION, TOKYO (JP)

(72) Inventors: DAISUKE FUNAMOTO, TOKYO (JP); YOSUKE KAWACHI, TOKYO (JP); TOSHIHIRO ISHIZAKA, TOKYO (JP)

(21) Appl. No.: 17/904,947

(22) PCT Filed: Feb. 18, 2021
(86) PCT No.: PCT/JP2021/006074

§ 371 Date: Aug. 24, 2022

(30) Foreign Application Priority Data
Mar. 4, 2020 (JP) 2020-036523

(51) Int. Cl. G06T 1/60; G06T 11/00

(52) U.S. Cl. CPC G06T 1/60; G06T 11/00

(57) ABSTRACT

The present technology relates to an image processing device and an image processing method capable of obtaining tile images of an appropriate image size. An image processing unit sets an image size of tile images, which form a grid image and are stored in a high efficiency image file format (HEIF) file, according to a target image size or a target bit rate of the tile images, and generates the tile images of the image size. The present technology can be applied to, for example, a digital camera or the like that generates an HEIF file in which tile images are stored.

### TECHNICAL FIELD

The present technology relates to an image processing device and an image processing method, and particularly relates to an image processing device and an image processing method capable of obtaining tile images of an appropriate image size, for example.

### BACKGROUND ART

As a file format for efficiently storing images, there is a High Efficiency Image File Format (HEIF) (see Non-Patent Document 1).

### CITATION LIST

### Non-Patent Document

Non-Patent Document 1: ISO/IEC 23008-12:2017, Information technology—High efficiency coding and media delivery in heterogeneous environments—Part 12: Image File Format

### SUMMARY OF THE INVENTION

### Problems to be Solved by the Invention

In the HEIF, a grid is defined as one of item types. An image (item) whose item type is the grid is formed by tiling one or more input images. An image whose item type is the grid is also referred to as a grid image, and an input image for forming the grid image is also referred to as a tile image.

In the HEIF, the image size of tile images forming the grid image is prescribed to be the same image size, but what image size is to be set is not prescribed.

The present technology has been made in view of such a situation, and enables to obtain tile images of an appropriate image size.

### Solutions to Problems

A first image processing device of the present technology is an image processing device including an image processing unit that sets an image size of tile images, which form a grid image and are stored in a high efficiency image file format (HEIF) file, according to a target image size or a target bit rate of the tile images, and generates the tile images of the image size.

A first image processing method of the present technology is an image processing method including setting an image size of tile images, which form a grid image and are stored in a high efficiency image file format (HEIF) file, according to a target image size or a target bit rate of the tile images, and generating the tile images of the image size.

In the first image processing device and image processing method of the present technology, an image size of tile images, which form a grid image and are stored in a high efficiency image file format (HEIF) file, is set according to a target image size or a target bit rate of the tile images, and the tile images of the image size are generated.

A second image processing device of the present technology is an image processing device including an image processing unit that sets an image size of tile images, which form a grid image and are stored in a high efficiency image file format (HEIF) file, according to information from an outside, and generates the tile images of the image size.

A second image processing method of the present technology is an image processing method including setting an image size of tile images, which form a grid image and are stored in a high efficiency image file format (HEIF) file, according to information from an outside, and generating the tile images of the image size.

In the second image processing device and image processing method of the present technology, an image size of tile images, which form a grid image and are stored in a high efficiency image file format (HEIF) file, is set according to information from an outside, and the tile images of the image size are generated.

Note that the image processing device may be an independent device or an internal block constituting one device.

Furthermore, the image processing device can be achieved by causing a computer to execute a program. The program can be provided by transmitting via a transmission medium or by recording on a recording medium.

### BRIEF DESCRIPTION OF DRAWINGS

FIG. 1 is a block diagram illustrating a configuration example of an embodiment of a digital camera to which the present technology is applied.

FIG. 2 is a diagram illustrating an example of a format of a Joint Photographic Experts Group (JPEG) file conforming to JPEG.

FIG. 3 is a diagram illustrating an example of an ISO base media file format.

FIG. 4 is a diagram illustrating an example of a format of an HEIF file conforming to HEIF.

FIG. 5 is a diagram illustrating an example of a format of the HEIF file in an image item format.

FIG. 6 is a diagram illustrating an example of an iprp box.

FIG. 7 is a diagram illustrating an example of a format of the HEIF file in an image sequence format.

FIG. 8 is a diagram illustrating an example of a trak box.

FIG. 9 is a diagram illustrating an example of a collection file storing a master image and a thumbnail image.

FIG. 10 is a diagram illustrating an example of a sequence file storing a track of master images and a track of thumbnail images of the master images.

FIG. 11 is a diagram illustrating an example of the HEIF file storing tile images.

FIG. 12 is a diagram illustrating an example of use cases where an image size or a bit rate of the tile images is limited.

FIG. 13 is a diagram illustrating an example of setting an image size of the tile images in a first use case.

FIG. 14 is a diagram illustrating an example of setting the image size of the tile images in a second use case.

FIG. 15 is a diagram illustrating an example of setting the image size of the tile images in a third use case.

FIG. 16 is a diagram illustrating a first example of four HEIF files before editing generated by four cameras in the third use case and a new HEIF file generated from the four HEIF files before editing in editing software.

FIG. 17 is a diagram illustrating a second example of four HEIF files before editing generated by the four cameras in the third use case and a new HEIF file generated from the four HEIF files before editing in the editing software.

FIG. 18 is a diagram illustrating a third example of four HEIF files before editing generated by the four cameras in the third use case and a new HEIF file generated from the four HEIF files before editing in the editing software.

FIG. 19 is a diagram illustrating a fourth example of four HEIF files before editing generated by the four cameras in the third use case and a new HEIF file generated from the four HEIF files before editing in the editing software.

FIG. 20 is a diagram illustrating an example of setting the image size of the tile images in a fourth use case.

FIG. 21 is a diagram illustrating an example of setting the image size of the tile images in a fifth use case.

FIG. 22 is a diagram illustrating an example of setting the image size of the tile images in a sixth use case.

FIG. 23 is a block diagram illustrating a configuration example of an encoding control unit 42.

FIG. 24 is a flowchart illustrating an example of processing of the image processing unit 110.

FIG. 25 is a diagram illustrating an example of an image size setting method of setting an image size of the tile images such that the image size of the tile images is equal to or smaller than a target image size.

FIG. 26 is a flowchart illustrating an example of processing of setting an image size of the tile images such that the image size of the tile images is equal to or smaller than the target image size.

FIG. 27 is a diagram illustrating an example of the image size setting method of setting the image size of the tile images such that the bit rate of the tile images is equal to or less than a target bit rate.

FIG. 28 is a diagram illustrating an example of the image size setting method of setting the image size of the tile images such that the image size and the bit rate of the tile images become equal to or less than the target image size and the target bit rate, respectively.

FIG. 29 is a block diagram illustrating a configuration example of an embodiment of a computer to which the present technology is applied.

### MODE FOR CARRYING OUT THE INVENTION

<One Embodiment of Digital Camera To Which Present Technology Is Applied>

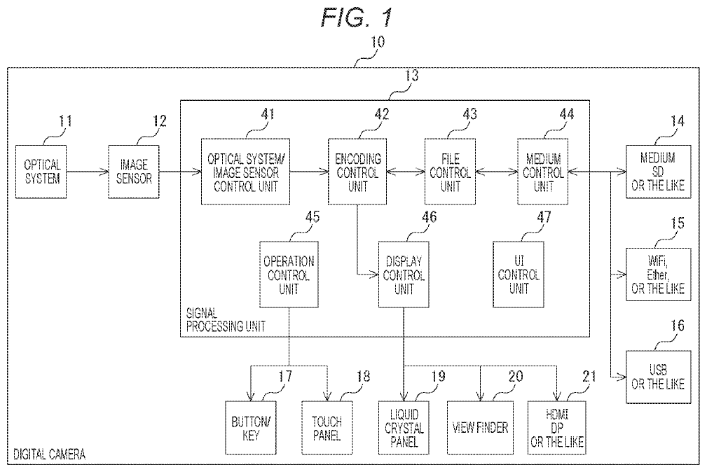

FIG. 1 is a block diagram illustrating a configuration example of an embodiment of a digital camera to which the present technology is applied.

The digital camera 10 includes an optical system 11, an image sensor 12, a signal processing unit 13, a medium 14, interfaces (I/Fs) 15 and 16, a button/key 17, a touch panel 18, a liquid crystal panel 19, a view finder 20, an I/F 21, and the like.

The optical system 11 condenses light from a subject on the image sensor 12.

The image sensor 12 receives light from the optical system 11, performs imaging for photoelectric conversion, generates image data as an electric signal, and supplies the image data to the signal processing unit 13.

The signal processing unit 13 includes an optical system/image sensor control unit 41, an encoding control unit 42, a file control unit 43, a medium control unit 44, an operation control unit 45, a display control unit 46, and a UI control unit 47.

The optical system/image sensor control unit 41 controls the optical system 11 and the image sensor 12, and supplies (data of) an image obtained by imaging performed in accordance with the control to the encoding control unit 42.

The encoding control unit 42 supplies the image from the optical system/image sensor control unit 41 to the display control unit 46, encodes the image as necessary, and supplies the encoded image to the file control unit 43. Furthermore, the encoding control unit 42 decodes the image supplied from the file control unit 43 as necessary, and supplies the decoded image to the display control unit 46.

The file control unit 43 generates a file storing the image supplied from the encoding control unit 42, and supplies the file to the medium control unit 44. Furthermore, the file control unit 43 reproduces the file supplied from the medium control unit 44, that is, reads data such as an image stored in the file, and the like. For example, the image read from the file is supplied from the file control unit 43 to the encoding control unit 42.

The medium control unit 44 controls exchange of files between the medium 14 and the I/Fs 15 and 16. For example, the medium control unit 44 causes the file from the file control unit 43 to be recorded on the medium 14 or transmitted from the I/Fs 15 and 16. Furthermore, the medium control unit 44 reads a file from the medium 14, or causes the I/Fs 15 and 16 to receive a file and supplies the file to the file control unit 43.

The operation control unit 45 supplies, according to an operation of the button/key 17 or the touch panel 18 by a user, an operation signal according to the operation to a necessary block.

The display control unit 46 performs display control or the like to supply the image or the like supplied from the encoding control unit 42 to the liquid crystal panel 19, the view finder 20, and the I/F 21 to cause display thereof.

The UI control unit 47 manages user interface (UI) control.

The medium 14 is, for example, a storage medium such as an SD card. The I/F 15 is, for example, an I/F of a local area network (LAN) such as WiFi (registered trademark) or Ethernet (registered trademark). The I/F 16 is, for example, a universal serial bus (USB) I/F. The button/key 17 and the touch panel 18 are operated by the user when a command or other information is input to the digital camera 10. The touch panel 18 can be formed integrally with the liquid crystal panel 19. The liquid crystal panel 19 and the view finder 20 display the image or the like supplied from the display control unit 46. The I/F 21 is an I/F that transmits at least an image, such as High-Definition Multimedia Interface (HDMI) (registered trademark) or Display Port (DP).

In the digital camera 10 configured as described above, the optical system/image sensor control unit 41 generates, for example, an image of YUV having the same resolution (number of pixels) (size) as that of the RAW image from an image of RAW data (hereinafter also referred to as a RAW image) obtained by imaging by the image sensor 12, and supplies the image to the encoding control unit 42 together with the RAW image. The encoding control unit 42 generates a master image or the like of an HEIF file from the image of YUV from the optical system/image sensor control unit 41. For example, the image of YUV from the optical system/image sensor control unit 41 can be directly used as the master image of the HEIF file.

The encoding control unit 42 generates, from the master image of YUV, an image of YUV (hereinafter also referred to as a screen nail image) having a resolution lower than that of the master image as, for example, a first other image based on the master image for use in display on the liquid crystal panel 19 or an external display, and generates an image of YUV (hereinafter also referred to as a thumbnail image) having a resolution lower than that of the screen nail image as, for example, a second other image based on the master image for use in index display (list display). For example, the encoding control unit 42 supplies the screen nail image to the liquid crystal panel 19 via the display control unit 46 to display the screen nail image as what is called a through image. As the thumbnail image, for example, an image having a size of 320 pixels or less on a long side can be employed. The ratio of the size (number of pixels) between the master image and the screen nail image as the first other image based on the master image or the thumbnail image as the second other image based on the master image can be, for example, 200 times or less. Similarly, the ratio of the sizes of the screen nail image as the first other image based on the master image and the thumbnail image as the second other image based on the master image can be 200 times or less. As the screen nail image, for example, an image having a resolution of 4K or more can be employed. Furthermore, as the screen nail image, for example, a 4K (QFHD) or FHD image can be employed according to the user's selection. Moreover, images having the same resolution can be employed as the master image and the screen nail image. In a case where images having the same resolution are employed as the master image and the screen nail image, both the master image and the screen nail image can be stored in the HEIF file, or the master image can be stored without storing the screen nail image. In a case where the master image is stored in the HEIF file without storing the screen nail image, the master image can be resized and used as the screen nail image.

Furthermore, the encoding control unit 42 encodes the master image, the screen nail image, and the thumbnail image (master image, screen nail image, and thumbnail image generated from same RAW image) corresponding to the RAW image as necessary, and supplies them to the file control unit 43 together with the RAW image.

The file control unit 43 generates a RAW file storing a RAW image, the HEIF file storing a corresponding master image, a screen nail image, and a thumbnail image (master image, screen nail image, and thumbnail image generated from same RAW image), and/or a JPEG file or the like as necessary, and supplies the generated file to the medium control unit 44. The HEIF file is a file conforming to High Efficiency Image File Format (HEIF), and the JPEG file is a file conforming to Joint Photographic Experts Group (JPEG).

The medium control unit 44 records the RAW file, the HEIF file, or the JPEG file from the file control unit 43 on the medium 14 or transmits the RAW file, the HEIF file, or the JPEG file from the I/F 15 or 16.

The type (for example, the RAW file, the HEIF file, the JPEG file, and the like) of the file to be generated by the file control unit 43 can be selected according to, for example, the user's operation (designation). Furthermore, as will be described later, the HEIF file includes an image item format and an image sequence format, and which one of the image item format and the image sequence format is employed can be selected according to the user's operation, for example. Moreover, the file control unit 43 can perform the mutual conversion between the HEIF file and the JPEG file according to the user's operation.

Furthermore, the file control unit 43 can generate a plurality of files that differs in codec and size (resolution), color format, and bit depth of the image and has the same image content.

In a case where the file control unit 43 generates a plurality of files having the same image content, the encoding control unit 42 generates a stream (file stream) of an image to be stored in each of the plurality of files from the image of YUV from the optical system/image sensor control unit 41.

The encoding control unit 42 can generate streams of images that differ in codec and size (resolution), color format, and bit depth of the image.

For example, the encoding control unit 42 can generate an image of a predetermined size, a predetermined color format, and a predetermined bit depth from the image of YUV supplied from the optical system/image sensor control unit 41, and generate a first stream obtained by encoding the image with a predetermined codec (encoding method). Moreover, the encoding control unit 42 can generate an image of another size, another color format, and another bit depth from the same image of YUV supplied from the optical system/image sensor control unit 41, and generate a second stream obtained by encoding the image with another codec.

Then, the file control unit 43 can generate a file storing the first stream and a file storing the second stream.

<JPEG File>

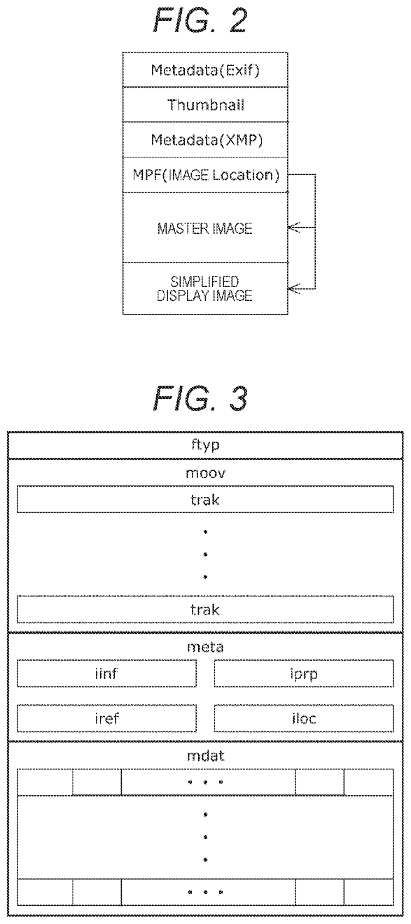

FIG. 2 is a diagram illustrating an example of a format of a Joint Photographic Experts Group (JPEG) file conforming to JPEG.

The JPEG file is configured to store, for example, metadata of Exif, thumbnail images, metadata of XMP (Extensible Metadata Platform) (registered trademark), an MPF representing storage locations (positions) or the like of a master image and a simplified display image, a master image, and a simplified display image. As the simple display image, for example, the screen nail image can be employed.

<ISO Base Media File Format>

FIG. 3 is a diagram illustrating an example of an ISO base media file format.

HEIF (ISO/IEC 23008-12) is a file format conforming to the ISO Base Media File Format (ISO/IEC 14496-12), and therefore, the HEIF file is conforming to the ISO Base Media File Format.

The ISO base media file format includes units called boxes as containers for storing data, and has a structure called a box structure.

The box includes a type (box type), actual data (data), and the like. The type represents a type of actual data in the box. As the actual data, reproducible media data such as image (still image and moving image), audio, and subtitles, attribute names (field names) and attribute values (field values) of (variables represented by) the attribute names, and various other data can be employed.

Moreover, a box can be employed as the actual data. That is, the box can have a box as actual data, and thus can have a hierarchical structure.

The base media file conforming to the ISO base media file format can include an ftyp box, a moov box (MovieBox), a meta box (MetaBox), an mdat box (MediaDataBox), and the like. The ftyp box stores identification information for identifying a file format. The moov box can store a trak box and the like. The meta box can store an iinf box, an iprp box, an iref box, an iloc box, and the like. The mdat box can store media data (AV data) and other arbitrary data.

The HEIF conforms to the ISO base media file format as described above.

<HEIF File>

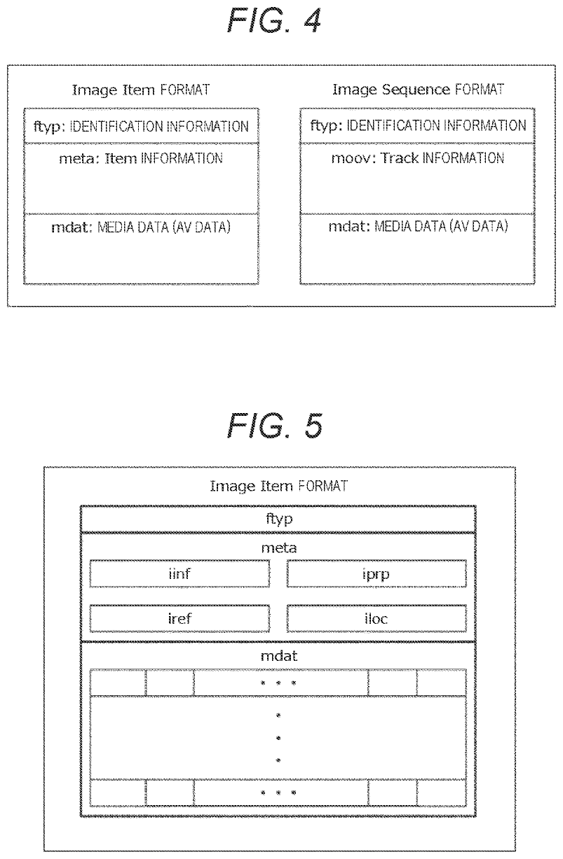

FIG. 4 is a diagram illustrating an example of a format of an HEIF file conforming to the HEIF.

The HEIF file is roughly divided into an image item format and an image sequence format. Moreover, the image item format includes a single image format having only one item to be described later and an image collection format having a plurality of items.

The HEIF file in the image item format includes the ftyp box, the meta box, and the mdat box.

The HEIF file in the image sequence format includes the ftyp box, the moov box, and the mdat box.

Note that the HEIF file can include not only one but also both of the meta box and the moov box.

The ftyp box stores identification information for identifying a file format, for example, that the file is the HEIF file in an image item format or an image sequence format, and the like.

In the meta box and the moov box, metadata necessary for reproduction, management, and the like of the media data stored in the mdat box, for example, a storage location of the media data, and the like is stored.

The mdat box stores media data (AV data) and the like.

In the digital camera 10, which of the HEIF files in the image item format and the image sequence format is to be generated can be selected according to the user's operation, for example. Furthermore, in a case where an image is encoded and stored in the mdat box of the HEIF file, only intra encoding is permitted for the image item format, and intra encoding and inter encoding are permitted for the image sequence format. Therefore, for example, in a case where priority is given to high-speed access to the data stored in the HEIF file, generation of the HEIF file in the image item format can be selected, and in a case where priority is given to reducing the size (data amount) of the HEIF file, generation of the HEIF file in the image sequence format can be selected.

FIG. 5 is a diagram illustrating an example of a format of the HEIF file in an image item format.

In the HEIF file in the image item format, information indicating that the HEIF file is in the image item format, for example, mif1 or the like is stored in the ftyp box (as an attribute value).

The meta box stores the iinf box, the iref box, the iprp box, and the iloc box.

The iinf box stores (the attribute name and the attribute value representing) the number of items that are the media data (AV data) stored in the mdat box, and the like. The item is a piece of data stored in the mdat box of the HEIF file in the image item format, and for example, one image (screen) is the item. In the present description, one image is also referred to as a frame regardless of a still image and a moving image. One frame is one item.

The iref box stores information indicating a relationship between items. For example, in the mdat box, each of the corresponding master image, screen nail image, and thumbnail image can be stored as an item. In a case where the item I1 as the master image, the item I2 as the screen nail image, and the item I3 as the thumbnail image are stored in the mdat box, information indicating that the item I2 is the screen nail image of the master image as the item I1 and information indicating that the item I3 is the thumbnail image of the master image as the item I1 are stored in the iref box.

The iprp box stores information regarding properties of an item.

The iloc box stores information regarding the storage location of the item stored in the mdat box.

The mdat box (of the HEIF file) in the image item format stores, for example, a frame of an image as an item. One or more items can be stored in the mdat box. Furthermore, the frame as an item can be encoded and stored in the mdat box. However, the encoding of the frame as an item stored in the mdat box in the image item format is limited to intra encoding. As an encoding method (codec) for encoding the frame as an item, for example, HEVC or the like can be employed.

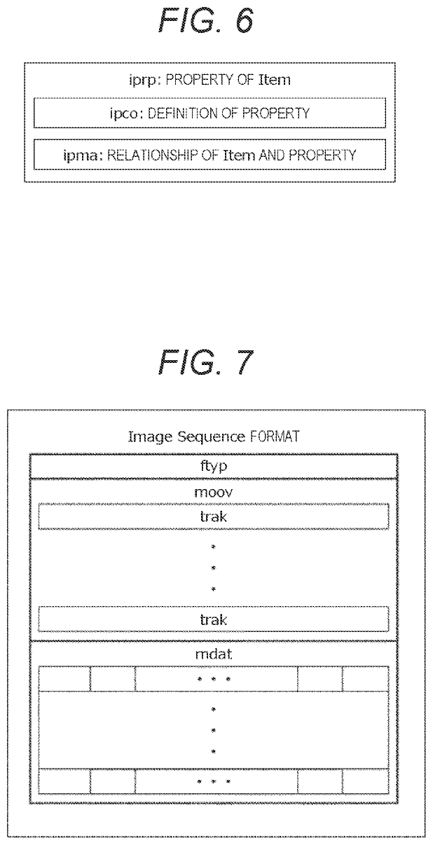

FIG. 6 is a diagram illustrating an example of the iprp box in FIG. 5.

The iprp box stores an ipco box and an ipma box related to the properties of the item. The ipco box stores the properties of the item stored in the mdat box, for example, codec information regarding the codec of the image as the item and image size information regarding a size. The ipma box stores an index (pointer) of the item stored in the mdat box to the property stored in the ipco box.

FIG. 7 is a diagram illustrating an example of a format of the HEIF file in an image sequence format.

In the HEIF file in the image sequence format, information indicating that the HEIF file is in the image sequence format, for example, msfl or the like is stored in the ftyp box.

The moov box stores the trak box. The trak box stores information regarding the track stored in the mdat box.

A track includes an independent piece of media data, such as an image or an audio, reproduced according to a timeline. For example, the track includes one or more frames of images to be an elementary stream. As for the track stored in the mdat box, a plurality of tracks, for example, the respective tracks of the image and audio recorded at the same time can be reproduced at the same time.

The media data of the track is configured in units called samples. The sample is a minimum unit (access unit) in a case where the media data in the HEIF file is accessed. Therefore, the media data in the HEIF file cannot be accessed in units finer than the samples.

For the media data of an image, for example, one frame or the like is one sample. Furthermore, for the media data of audio, for example, one audio frame or the like defined in the standard of the media data of audio is one sample.

In the mdat box (of the HEIF file) in the image sequence format, the media data of the track is arranged in units called chunks. A chunk is a set of one or more samples arranged at logically continuous addresses.

In a case where a plurality of tracks as media data is stored in the mdat box, the plurality of tracks is interleaved and arranged in units of chunks.

As described above, the mdat box in the image sequence format stores one or more tracks including media data such as an image and audio.

In the mdat box, frames of images constituting the track can be encoded and stored. In the encoding of the frame constituting the track stored in the mdat box of the image sequence format, a long GOP can be employed as a group of picture (GOP), and both intra encoding and inter encoding can be employed. As the codec that encodes a frame constituting a track, for example, HEVC or the like can be employed.

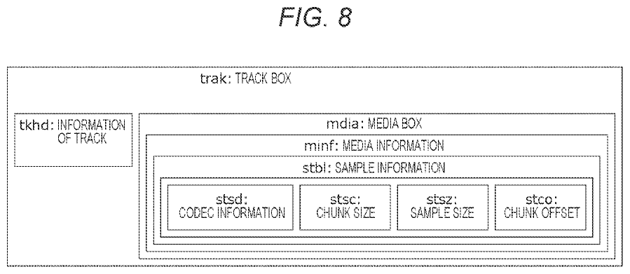

FIG. 8 is a diagram illustrating an example of the trak box.

In the trak box, a tkhd box and an mdia box can be stored. The tkhd box stores header information of the track such as a creation date and time of the track managed by the trak box. The mdia box stores a minf box and the like. The minf box stores an stbl box. The stbl box stores an stsd box, an stsc box, an stsz box, and an stco box that store a sample of a track and, consequently, information for accessing the chunk. The stsd box stores codec information regarding the codec of the track. The stsc box stores a chunk size (the number of samples of one chunk). The stsz box stores a sample size. The stco box stores a chunk offset, that is, an offset of an arrangement position of each chunk of the track stored in the mdat box.

Here, the HEIF file in the image item format is also referred to as a collection file, and the HEIF file in the image sequence format is also referred to as a sequence file.

In the digital camera 10, it is possible to generate an HEIF file storing one or both of the master image and the necessary screen nail image and thumbnail image.

<Collection File>

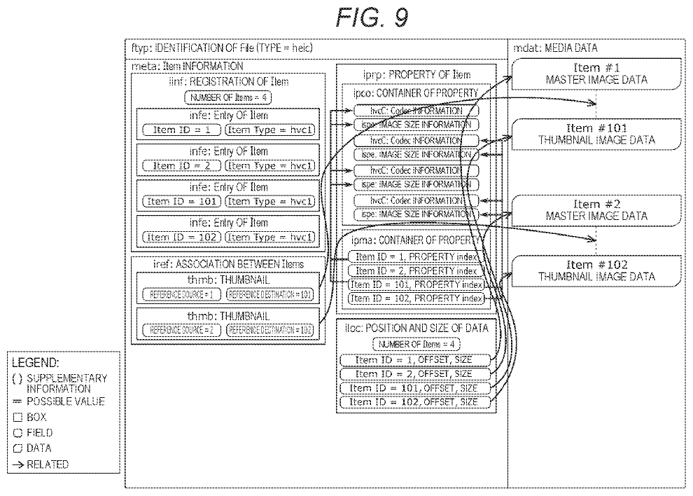

FIG. 9 is a diagram illustrating an example of a collection file storing a master image and a thumbnail image.

Now, it is assumed that a frame (item) is encoded by HEVC and stored in the mdat box of the collection file.

The ftyp box stores, as identification information for identifying a file format, heic indicating that the format is an image item format and that the codec is HEVC.

The iinf box stores the number of items (the number of items) stored in the mdat box. In FIG. 9, a total of four items (frames) including a master image specified by an item ID #1 (hereinafter also described as a master image Item #1), a master image Item #2, a thumbnail image specified by an item ID #101 (hereinafter also described as a thumbnail image Item #101), and a thumbnail image Item #102 are stored in the mdat box. Therefore, the number of items is four. Note that the thumbnail image Item #101 is a thumbnail image of the master image Item #1, and the thumbnail image Item #102 is a thumbnail image of the master image Item #2.

The iinf box further stores, for example, an infe box for every item stored in the mdat box. In the infe box, an item ID for specifying an item and an item type are registered. In FIG. 9, there are respective infe boxes of the master images Item #1 and Item #2 and the thumbnail images Item #101 and Item #102.

The iref box stores, for example, a thmb box as information for associating items stored in the mdat box. In the thmb box, a reference source and a reference destination as information for associating the master image with the thumbnail image of the master image are stored in association with each other. In the thmb box, the reference source indicates the item ID of the master image, and the reference destination indicates the item ID of the thumbnail image of the master image specified by the item ID of the reference source. Therefore, according to the reference destination associated with the reference source, the item ID of the thumbnail image of the master image specified by the item ID indicated by the reference source can be recognized. Furthermore, according to the reference source associated with the reference destination, the item ID of the master image of the thumbnail image specified by the item ID indicated by the reference destination can be recognized.

The iprp box stores, as described in FIG. 6, the ipco box and the ipma box. The ipco box stores, as described in FIG. 6, properties of a frame as an item stored in the mdat box, for example, the codec information regarding the codec and the image size information regarding the size. The ipma box stores, as described in FIG. 6, an index of the item stored in the mdat box to the property stored in the ipco box.

The iloc box stores, as described in FIG. 6, the information regarding the storage location of the item in the mdat box. In FIG. 9, the iloc box stores that the number of items is four. Moreover, in the iloc box, offsets and sizes to respective storage places of the master images Item #1 and Item #2 and the thumbnail images Item #101 and Item #102 stored in the mdat box are stored in association with the item ID.

<Sequence File>

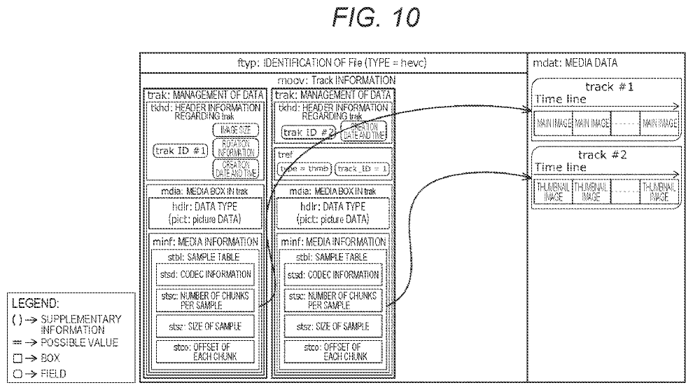

FIG. 10 is a diagram illustrating an example of a sequence file storing a track of master images and a track of thumbnail images of the master images.

Now, it is assumed that the frame is encoded by HEVC and stored in the mdat box of the sequence file.

The ftyp box stores, as identification information for identifying the file format, hevc indicating that the format is the image sequence format and the codec is HEVC.

The moov box stores, as described in FIG. 7, the trak box that manages each track stored in the mdat box. In FIG. 10, the track of the master images that is specified by the track ID #1 (hereinafter also described as track #1) and the track #2 of the thumbnail images of the master images of the track #1 are stored in the mdat box. Therefore, the moov box stores the trak box that manages the track #1 and the trak box that manages the track #2. (The frame of) an nth thumbnail image of the track #2 is a thumbnail image of an nth master image of the track #1.

For example, in a case where continuous imaging has been performed with the digital camera 10, the sequence file is useful in a case where master images and thumbnail images of a plurality of frames obtained by the continuous imaging are each recorded as one track, or the like.

The tkhd box of the trak box that manages the track #1 of the master images stores the track ID #1 that specifies the track #1, the image size of the master images constituting the track #1, rotation information indicating the direction of the digital camera 10 when the master image is captured, and the creation date and time of the track #1. In the tkhd box of the trak box that manages the track #2 of the thumbnail images, the track ID #2 that specifies the track #2 and the creation date and time of the track #2 are stored.

In the trak box, in addition to the tkhd box and the mdia box described in FIG. 7, a tref box can be stored. The tref box stores the track ID for specifying another track associated with the track managed by the trak box storing the tref box, information indicating the contents of the track, and the like. In FIG. 10, the tref box is provided in the trak box that manages the track #2. Then, the tref box stores information indicating that another track related to the track #2 is the track #1 (track_ID=1) and that the data constituting the track #2 is a thumbnail image (track #2 is a track of a thumbnail image) (type=thmb).

In the mdia box of the trak box, in addition to the minf box described in FIG. 8, an hdlr box can be stored. The hdlr box stores information indicating the type of data constituting the track managed by the trak box storing the hdlr box. Information (pict) indicating that data constituting the track #1 is a picture (frame) is stored in the hdlr box stored (in the mdia box stored) in the trak box that manages the track #1 of the master images, and information indicating that data constituting the track #2 is a picture is stored in the hdlr box stored in the trak box that manages the track #2 of the thumbnail image.

The minf box is as described in FIG. 8.

<HEIF File Storing Tile Images>

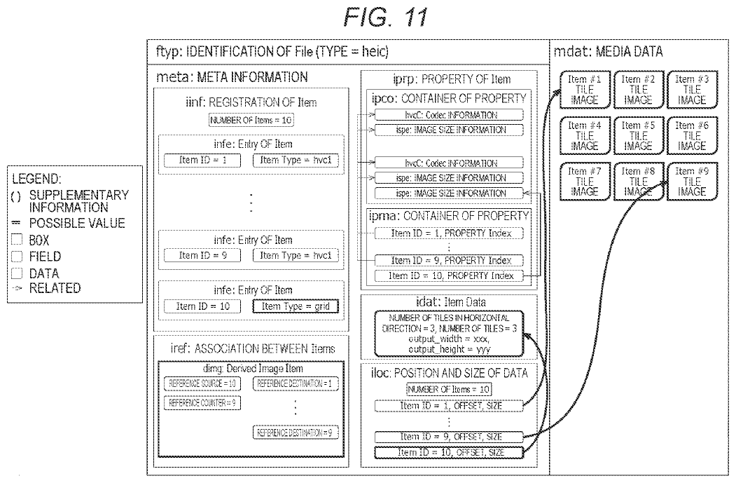

FIG. 11 is a diagram illustrating an example of the HEIF file storing the tile images.

Here, as described above, there is grid as one of the item types of HEIF. A grid image whose item type is an image (item) of grid is formed by tiling one or more tile images.

As the tile images, for example, a divided image obtained by dividing an image captured by the digital camera 10 or the like can be employed.

Furthermore, as the tile images, the image itself captured by the digital camera 10 or the like can be employed, and the grid image can include one or more of such tile images. For example, a plurality of images captured by a plurality of cameras can be used as tile images, and the grid image can include such a plurality of tile images.

Hereinafter, in order to make the description easy to understand, unless otherwise specified, a divided image obtained by dividing the image captured by the digital camera 10 or the like is employed as a tile image.

For a grid image whose item type is grid, each of (one or more) tile images forming the grid image is stored in the HEIF file as an item.

Note that, for the grid image, the grid image itself is not stored in the HEIF file, but the tile images forming the grid image are stored in the HEIF file. However, in the present description, for convenience, the HEIF file storing the tile images is also referred to as the HEIF file storing the grid image including the tile images.

FIG. 11 illustrates an example of the HEIF file storing (the tile images forming) the grid image.

In the HEIF file of FIG. 11, for example, nine images obtained by dividing the image captured (hereinafter also referred to as a captured image) by the digital camera 10 into 3×3 (horizontal×vertical) images are stored as tile images Item #1 to Item #9, and the tile images Item #1 to Item #9 are stored as items in the mdat box.

In FIG. 11, the items stored in the mdat box are nine items of the tile images Item #1 to Item #9, and the number of items in the iinf box and the iloc box is 10. This is because a grid image (reconstructed image) including the tile images Item #1 to Item #9 are counted as items in addition to the nine items of the tile images Item #1 to Item #9. In FIG. 11, the item ID of the grid image is 10, and for convenience of description, the grid image is also referred to as a grid image Item #10.

For the grid image Item #10, the media data is not stored in the mdat box, and instead, an idat box is stored in the meta box. The idat box stores metadata of the grid image such as the number of tiles in a horizontal direction, the number of tiles in a vertical direction, output_width, and output_height.

The number of tiles in the horizontal direction and the number of tiles in the vertical direction indicate the numbers of tile images #1 to #9 constituting the grid image Item #10 in the horizontal direction and the vertical direction, respectively.

Output_width and output_height represent the horizontal and vertical sizes (the number of pixels) of a canvas, which is an image area in which tile images forming the grid image are tiled (arranged). Assuming that the numbers of pixels in the horizontal and vertical directions of the tile images are represented as tile_width and tile_height, respectively, tile_width×the number of tiles in the horizontal direction needs to be output_width or more, and tile_height×the number of tiles in the vertical direction needs to be output_height or more.

Moreover, regarding the grid image Item #10, information (offset and size) regarding the storage location of the grid image Item #10 is stored in the iloc box, and this information indicates the storage location of the idat box of the grid image Item #10.

The HEIF file of FIG. 11 includes 10 infe boxes according to that the storage of 10 items of the tile images Item #1 to Item #9 and the tile image Item #10 formed by the tile images Item #1 to Item #9. As described in FIG. 9, the item ID specifying the item and the item type are stored (registered) in the infe box, and grid representing a grid item is stored as the item type of the grid image Item #10 in the infe box of the grid image Item #10. The item whose item type is grid, here, the grid image Item #10 is referred to as a grid item.

In the HEIF file in which the grid item is stored, a dimg box is stored in the iref box. The dimg box stores information associating the grid item with tile images constituting the grid item. For example, in the dimg box, an item ID of a tile image is stored as the reference destination, and an item ID of a grid image including the tile image is stored as the reference source. In FIG. 11, the item IDs #1 to #9 of the tile images Item #1 to Item #9 are stored as reference destinations, and the item ID #10 of the grid image Item #10 is stored as a reference source. In addition, a reference counter indicating the number of tile images forming the grid image is stored in the dimg box.

For the HEIF file as described above, the file control unit 43 can recognize that the grid image Item #10 is the grid item (reconstructed image) formed by one or more tile images from the item type grid stored in the infe box of the grid image Item #10. Moreover, the file control unit 43 can specify the item ID #10 of the grid image Item #10 including the tile images and the item IDs #1 to #9 of the tile images Item #1 to Item #9 used to form the grid image Item #10 from the reference source and the reference destination stored in the dimg box. Furthermore, the file control unit 43 can specify the numbers in the horizontal direction and the vertical direction of tile images #1 to #9 forming the grid image #10, and the sizes in the horizontal direction and the vertical direction of the canvas on which the tile images #1 to #9 are arranged when forming the grid image #10, from the number of tiles in the horizontal direction and the number of tiles in the vertical direction, and output_width and output_height stored in the idat box.

The file control unit 43 arranges the numbers of tile images in the horizontal direction and the vertical direction specified from the idat box from the tile images Item #1 to Item #9 of the item IDs #1 to #9 specified from the dimg box on the canvas having the size specified from the idat box, thereby forming the grid image Item #10 of the item ID #10 specified from the dimg box.

Hereinafter, use cases in which the image size and the bit rate (data amount) of the tile images stored in the HEIF file are limited will be described.

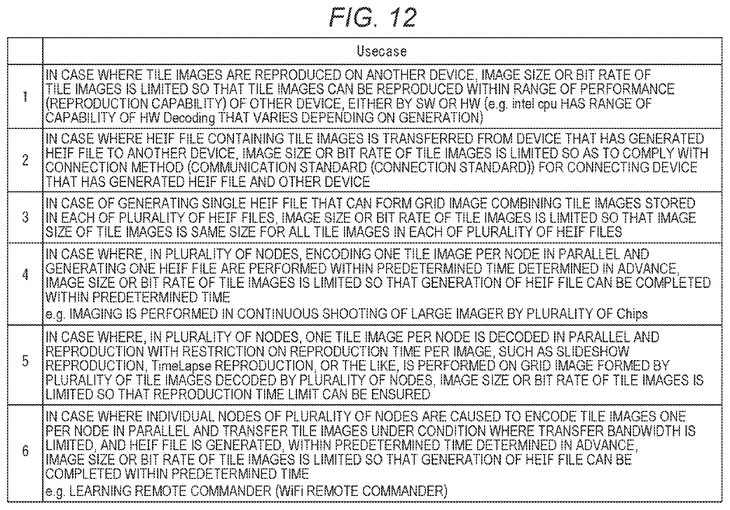

FIG. 12 is a diagram illustrating an example of use cases where the image size or the bit rate of the tile images is limited.

As a first use case where the image size or the bit rate of the tile images is limited, for example, there is a case where the tile images stored in the HEIF file are reproduced by a device other than a device that has generated the HEIF file. In this case, the image size or the bit rate of the tile images is limited so that reproduction such as decoding of the tile images can be performed by software (SW) or hardware (HW) within the range of the performance (reproduction capability) of other devices. For example, CPUs of Intel Corporation have different performances such as a range of image sizes in which a hardware code can be made depending on the generation. In a case where the tile images are reproduced by the CPU, the image size and the like of the tile images are limited by the performance of the CPU.

As a second use case where the image size or the bit rate of the tile images is limited, for example, there is a case where the HEIF file storing the tile images is transferred from the device that has generated the HEIF file to another device. In this case, the image size or the bit rate of the tile images is limited so as to comply with, for example, a communication standard (connection standard) as a connection method for connecting a device that has generated the HEIF file and another device.

As a third use case where the image size or the bit rate of the tile images is limited, for example, there is a case of generating one HEIF file in which tile images respectively stored in a plurality of HEIF files are collectively stored and a grid image can include the tile images. In this case, the image size or the bit rate of the tile images is limited such that the image size of the tile images is the same in all the respective tile images of the plurality of HEIF files.

As a fourth use case where the image size or the bit rate of the tile images is limited, for example, there is a case where encoding one tile image per node in parallel in a plurality of nodes as processing blocks that process the tile images and generating the HEIF file storing the tile images encoded in each of the plurality of nodes are performed within a predetermined time determined in advance. In this case, the image size or the bit rate of the tile images is limited so that generation of the HEIF file including the encoding of the tile images at the node can be completed within the predetermined time. For example, this corresponds to a case where images captured by continuous imaging with an imager having a large size are used as the grid image, and a plurality of tile images forming the grid image is processed by a (semiconductor) chip as a plurality of nodes.

A fifth use case where the image size or the bit rate of the tile images is limited is, for example, a case where one tile image per node is decoded in parallel in a plurality of nodes as processing blocks that process the tile images, and slide show reproduction, time lapse reproduction, and the like are performed on a grid image including a plurality of tile images decoded in a plurality of nodes. In this case, since the reproduction time of one (frame) is restricted, the image size or the bit rate of the tile images is limited so that the restriction of the reproduction time can be ensured (so that the grid image can be formed within the reproduction time).

A sixth use case where the image size or the bit rate of the tile images is limited is, for example, a case where individual nodes of a plurality of nodes as processing blocks that process the tile images is caused to encode the tile images one per node in parallel and transfer the tile images under a condition where the transfer band is limited, and generation of the HEIF file is performed at a transfer destination, within a predetermined time determined in advance. In this case, the image size or the bit rate of the tile images is limited so that the tile images can be transferred in a transfer band of a limited condition, and the generation of the HEIF file can be completed within the predetermined time. For example, this corresponds to a case where, according to an operation of what is called learning remote commander (smart remote commander) (WiFi remote commander), the tile images stored in the HEIF file are transferred from the camera to the storage.

The image size or the bit rate of the tile images stored in the HEIF file is limited by, for example, a profile, a level, or a tier of a codec corresponding to a device that handles the tile images. For example, the image size of the tile images is limited to the image size prescribed in the level of the codec supported by the device that handles the tile images. Furthermore, for example, the bit rate of the tile images is limited to the bit rate prescribed by the profile, level, or tier of the codec supported by the device that handles the tile images.

Note that, in a case where there is a limit on chroma sampling (chroma format) and an encoder tool corresponding to a device that handles tile images, the bit rate of the tile images is limited to a bit rate prescribed by a profile that prescribes the chroma sampling and the encoder tool corresponding to the device that handles tile images.

In the digital camera 10, when the image size of the tile images is arbitrarily set, a problem may occur in a use case where the image size or the bit rate of the tile images is limited as described above.

Accordingly, in the present technology, the image size of the tile images is appropriately set, and the tile images having the image size (hereinafter also referred to as a set image size) appropriately set as described above can be generated.

In the present technology, by appropriately setting the set image size, it is possible to achieve
ensuring reproduction compatibility when the tile images forming the grid image as content captured by the digital camera 10 are reproduced by another device,
compliance with a communication standard (connection standard) for performing communication between the digital camera 10 and another device, which is required when the tile images for forming the grid image are transferred from the digital camera 10 to another device,
collecting tile images forming the grid image stored in a plurality of HEIF files, and editing, without transcoding, to generate the HEIF file storing the tile images forming a new grid image,
in a case where encoding and decoding of a plurality of tile images forming the grid image is performed in parallel by a plurality of nodes, ensuring that a generation time for generating the HEIF file storing the tile images after encoding and a reproduction time for reproducing the grid image including the tile images after decoding are within a predetermined time according to performance of the nodes, for example, a throughput at which a node encodes the tile images, and a throughput at which the node decodes (reproduces) the tile images,
ensuring that a transfer time for transferring the tile images from the node is within a predetermined time according to a transfer band (transfer throughput), and the like.

The image size (set image size) of the tile images can be set according to information from the outside of the digital camera 10, for example, the performance of an external device acquired by the user's operation on a menu screen or the like of the digital camera 10 or negotiation with the external device as another device that communicates with the digital camera 10, the communication standard as the connection method which the digital camera 10 and the external device conform to when communicating with each other, and the like.

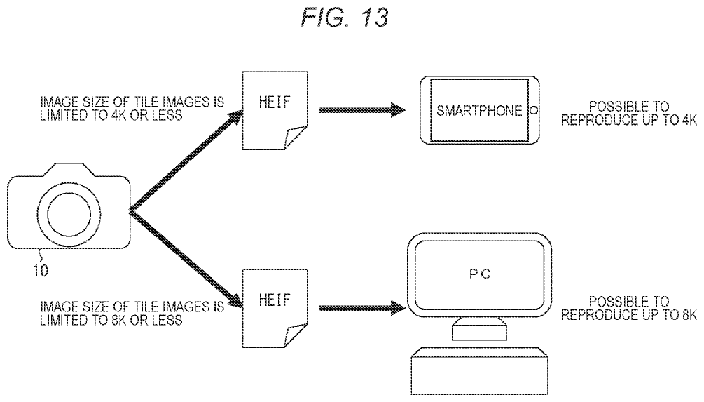

FIG. 13 is a diagram illustrating an example of setting the image size of the tile images in the first use case.

FIG. 13 illustrates a case where the HEIF file generated by the digital camera 10 and storing the tile images is transferred to a smartphone, a personal computer (PC), or the like as an external device, and the tile images stored in the HEIF file are reproduced by the external device.

For example, the manufacturer of the digital camera 10 can set the image size of the tile images by rewriting the firmware of the digital camera 10 with new firmware as information from the outside in consideration of reproduction environment of the world.

For example, in a case where it is recognized that an external device such as a smartphone or a PC supports what is called a 4K image has become a global standard, the manufacturer of the digital camera 10 can rewrite firmware of the digital camera 10 so as to set the image size of the tile images to the image size of the 4K image. The firmware of the digital camera 10 can be rewritten by communication or the like via the I/F 15. Thereafter, for example, in a case where it is recognized that the external device supports what is called an 8K image has become a global standard, the manufacturer of the digital camera 10 can rewrite firmware of the digital camera 10 so as to set the image size of the tile images to the image size of the 8K image.

In the digital camera 10, the image size of the tile images can be set according to the user's operation on the menu screen of the digital camera 10 as information from the outside.

For example, in a case where the HEIF file is transferred to the smartphone supporting reproduction of up to 4K images, the user can operate the menu screen to set the image size of the tile images stored in the HEIF file to an image size equal to or smaller than the image size of the 4K images. Furthermore, for example, in a case where the HEIF file is transferred to a PC supporting reproduction of up to 8K images, the user can operate the menu screen to set the image size of the tile images stored in the HEIF file to an image size equal to or smaller than the image size of the 8K images.

In the digital camera 10, the image size of the tile images can be set according to the performance (reproduction capability) of a smartphone or a PC as the external device connected to the digital camera 10.

For example, in a case where the digital camera 10 is connected to the smartphone supporting reproduction of up to 4K images and the HEIF file is transferred, the digital camera 10 negotiates with the smartphone and can set the image size of the tile images stored in the HEIF file to an image size (for example, 4K) equal to or smaller than the image size of the 4K image according to the fact, which is acquired by the negotiation, that the smartphone supports reproduction of up to 4K images. Furthermore, for example, in a case where the digital camera 10 is connected to a PC supporting reproduction of up to 8K images and the HEIF file is transferred, the digital camera 10 negotiates with the PC and can set the image size of the tile images stored in the HEIF file to an image size (for example, 8K) equal to or smaller than the image size of the 8K image according to the fact, which is acquired by the negotiation, that the PC supports reproduction of up to 8K images.

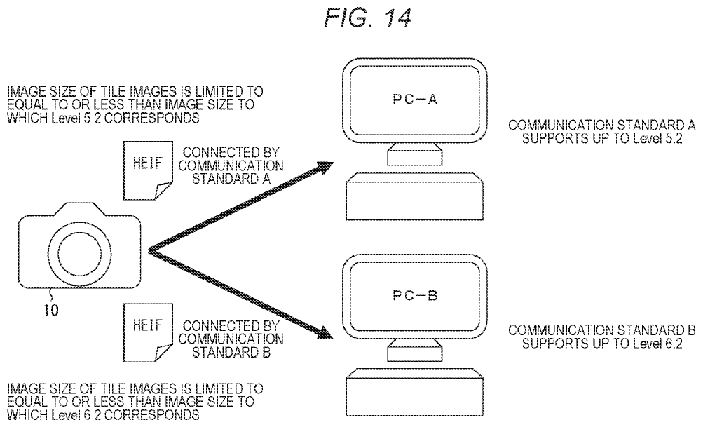

FIG. 14 is a diagram illustrating an example of setting the image size of the tile images in the second use case.

FIG. 14 illustrates a case where the HEIF file generated by the digital camera 10 and storing the tile images is transferred to a personal computer (PC)-A, a PC-B, or the like as the external device, and the tile images stored in the HEIF file are reproduced by the external devices.

In the digital camera 10, the image size of the tile images can be set according to a communication standard supported by the external device as information from the outside.

For example, in a case where the HEIF file is transferred to the PC-A corresponding to the communication standard A supporting up to a codec level of 5.2, the digital camera 10 can set the image size of the tile images stored in the HEIF file to an image size equal to or smaller than the image size to which the level 5.2 corresponds according to the communication standard A to which the PC-A corresponds. Furthermore, for example, in a case where the HEIF file is transferred to the PC-B corresponding to the communication standard B supporting up to a codec level of 6.2, the digital camera 10 can set the image size of the tile images stored in the HEIF file to an image size equal to or smaller than the image size to which the level 6.2 corresponds according to the communication standard B to which the PC-B corresponds. In the digital camera 10, the communication standards supported by the PC-A and the PC-B can be acquired by, for example, negotiation between the digital camera 10 and each of the PC-A and the PC-B.

Furthermore, in a case where the external device supports a plurality of communication standards, the digital camera 10 can determine the communication standard for transferring the HEIF file to the external device through negotiation with the external device, and can set the image size of the tile images stored in the HEIF file according to the communication standard.

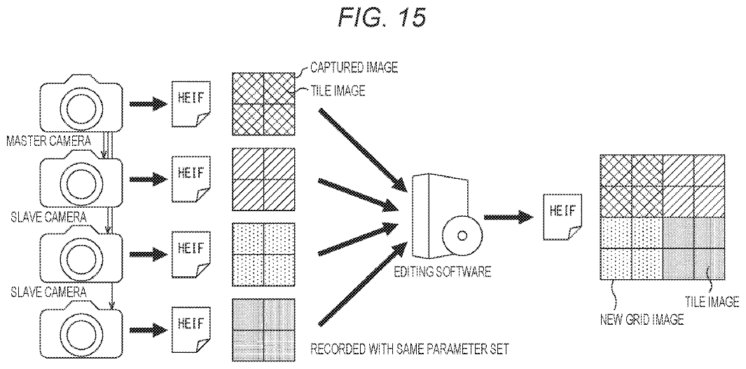

FIG. 15 is a diagram illustrating an example of setting the image size of the tile images in the third use case.

FIG. 15 illustrates a case where four HEIF files are combined into one HEIF file (one new HEIF file combining four HEIF files is generated) in editing software so that a new grid image in which the tile images stored in each of four HEIF files generated by a plurality of four cameras can be formed.

The four cameras that generate the HEIF files before editing, which are materials input to the editing software, are configured similarly to the digital camera 10, for example.

The tile images that are stored in the new HEIF file generated by the editing software and form the new grid image need to have the same image size in accordance with the HEIF standard. Therefore, the four cameras that generate the HEIF files before editing generate the HEIF files before editing by using the same parameter set as a parameter set such as the image size and chroma sampling of the tile images forming the grid image.

In FIG. 15, in each of the four cameras, images of the same image size (images to be grid images) are captured, and the HEIF files storing the tile images obtained by dividing the images into 2×2 (horizontal×vertical) images are generated. Then, in the editing software, the new HEIF file storing the tile images stored in the HEIF files generated by the four cameras is generated so that the new grid image can be formed by collecting the tile images stored in the HEIF files generated by the four cameras.

Since the four cameras generate the HEIF files before editing by using the same parameter set, for example, one camera among the four cameras is set as a master camera and the remaining three cameras are set as slave cameras. For example, the user operates one of the four cameras to set the camera as the master camera. The master camera communicates with the remaining three cameras, and sets the three cameras as the slave cameras.

The master camera sets the image size of the tile images, and instructs the image size of the tile images through communication with the three slave cameras. The other cameras set the image size of the tile images to the same image size as that of the master camera in response to an instruction from the master camera as information from the external device.

For example, the master camera can set the image size of the tile images according to the user's operation. Furthermore, for example, the master camera communicates with the three slave cameras to collect codec performance of the three slave cameras, for example, one or more of the profile, level, and tier of the codec as information from the external device, and can set the image size of the tile images to the image size corresponding to the lowest performance.

For the four cameras, one of the cameras is set as the master camera, and the remaining three cameras are set as the slave cameras, and moreover, in a case where the four cameras can communicate with an external device such as a cloud, the image size of the tile images can be set according to an instruction from the cloud. The cloud can set image sizes instructed to the four cameras, for example, similarly to the master camera.

Furthermore, in a case where the four cameras can communicate with the editing software (hardware such as a PC on which the editing software is mounted), the four cameras can set the image size of the tile images according to the function and performance of the editing software.

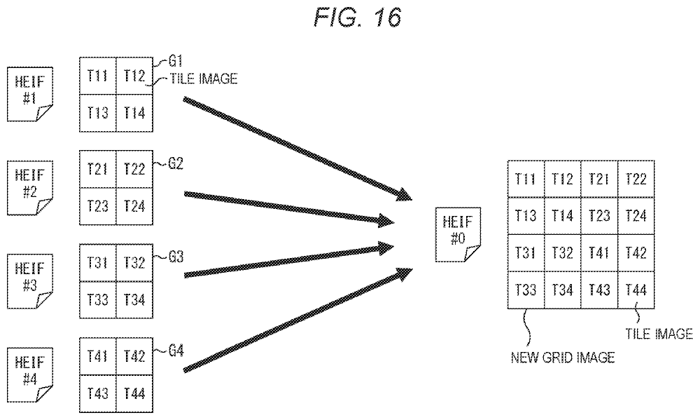

FIG. 16 is a diagram illustrating a first example of four HEIF files before editing generated by the four cameras in the third use case and a new HEIF file generated from the four HEIF files before editing in the editing software.

In FIG. 16, four cameras capture images G1, G2, G3, and G4 of the same image size, and HEIF files #1, #2, #3, and #4 storing the tile images obtained by dividing the images G1, G2, G3, and G4 into 2×2 are generated as the HEIF files before editing.

Then, in FIG. 16, an HEIF file #0 storing the tile images stored in the HEIF files #1 to #4 is generated as a new HEIF file such that a new grid image is formed in which 2×2 tile images stored in the HEIF files #1 to #4 before editing are respectively arranged on an upper left, an upper right, a lower left, and a lower right.

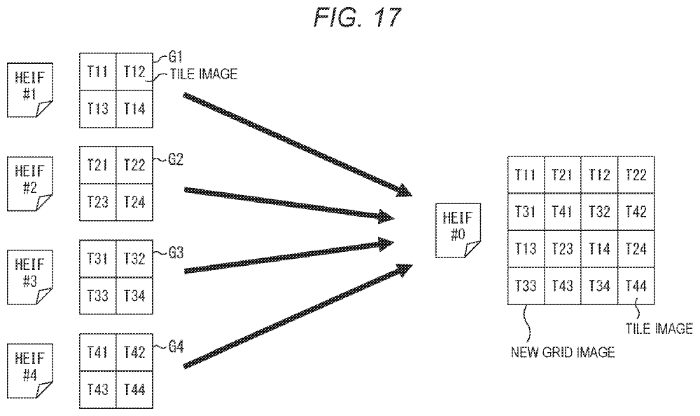

FIG. 17 is a diagram illustrating a second example of four HEIF files before editing generated by the four cameras in the third use case and a new HEIF file generated from the four HEIF files before editing in the editing software.

In FIG. 17, as in FIG. 16, the images G1 to G4 having the same image size are captured by four cameras, and the HEIF files #1 to #4 before editing in which tile images obtained by dividing the images G1 to G4 into 2×2 are stored are generated.

Here, the upper left, upper right, lower left, and lower right tile images among the 2×2 tile images stored in the HEIF file #i are represented as tile images Ti1, Ti2, Ti3, and Ti4, respectively.

In FIG. 17, the new HEIF file #0 is generated such that a new grid image is formed in which tile images T11, T21, T31, and T41 are arranged on the upper left, tile images T12, T22, T32, and T42 are arranged on the upper right, tile images T13, T23, T33, and T43 are arranged on the lower left, and tile images T14, T24, T34, and T44 are arranged on the lower right.

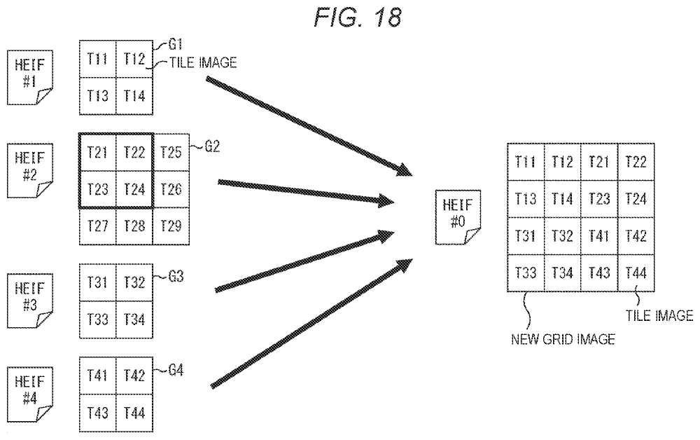

FIG. 18 is a diagram illustrating a third example of four HEIF files before editing generated by the four cameras in the third use case and a new HEIF file generated from the four HEIF files before editing in the editing software.

In FIG. 18, as in FIG. 16, three cameras out of the four cameras capture the images G1, G3, and G4 having the same image size, and the HEIF files #1, #3, and #4 storing tile images T11 to T14, T31 to T34, and T41 to T44 obtained by dividing the images G1, G3, and G4 into 2×2 are generated as HEIF files before editing.

Moreover, in FIG. 18, an image G2 having an image size 3/2 times as large as the images G1, G3, and G4 in both the horizontal and vertical directions is captured by the remaining one camera, and the HEIF file #2 storing the tile images T21 to T29 obtained by dividing the image G2 into 3×3 is generated as the HEIF file before editing.

The tile images stored in the HEIF files #1 to #4 have the same parameter set such as image size.

In FIG. 18, the new HEIF file #0 storing the tile images T11 to T14, T21 to T24, T31 to T34, and T41 to T44 stored in the HEIF files #1 to #4 is generated such that a new grid image is formed in which the 2×2 tile images T11 to T14 stored in the HEIF file #1 the 2×2 tile images T21 to T24 (portion surrounded by thick frame in the drawing) selected from the 3×3 tile images T21 to T29 stored in the HEIF file #2, the 2×2 tile images T31 to T34 stored in the HEIF file #3, and the 2×2 tile images T41 to T44 stored in the HEIF file #4 are arranged in the upper left, upper right, lower left, and lower right, respectively.

The selection of 2×2 tile images to be stored in the new HEIF file #0 among the 3×3 tile images T21 to T29 stored in the HEIF file #2 can be performed, for example, according to the user's operation or the like in the editing software.

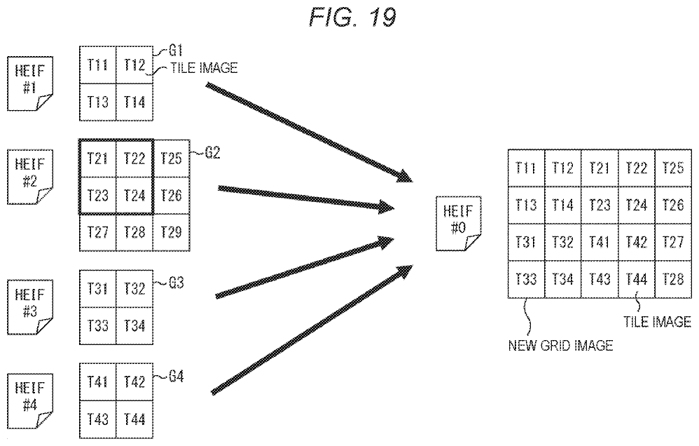

FIG. 19 is a diagram illustrating a fourth example of four HEIF files before editing generated by the four cameras in the third use case and a new HEIF file generated from the four HEIF files before editing in the editing software.

In FIG. 19, as in FIG. 18, the HEIF files #1 to #4 before editing are generated.

In FIG. 19, the new HEIF file #0 storing the tile images T11 to T14, T21 to T28, T31 to T34, and T41 to T44 stored in the HEIF files #1 to #4 is generated such that a new grid image is formed in which 2×2 tile images T21 to T24 selected as in FIG. 18 from 3×3 tile images T21 to T29 stored in the HEIF file #2, 2×2 tile images T31 to T34 stored in the HEIF file #3, and 2×2 tile images T41 to T44 stored in the HEIF file #4 are arranged on the right side, the lower side, and the diagonally lower right side, respectively, of 2×2 tile images T11 to T14 stored in the HEIF file #1, and four tile images T25 to T28 of the remaining tile images T25 to T29 of 3×3 tile images T21 to T29 stored in the HEIF file #2 are arranged on the right end.

The new grid image can be formed by arranging the same number of tile images (in FIG. 18, four tile images) from the tile images respectively stored in the HEIF files #1 to #4 as illustrated in FIG. 18, or can be formed by arranging non-same numbers of tile images (in FIG. 19, four tile images and eight tile images) from the tile images respectively stored in the HEIF files #1 to #4 as illustrated in FIG. 19.

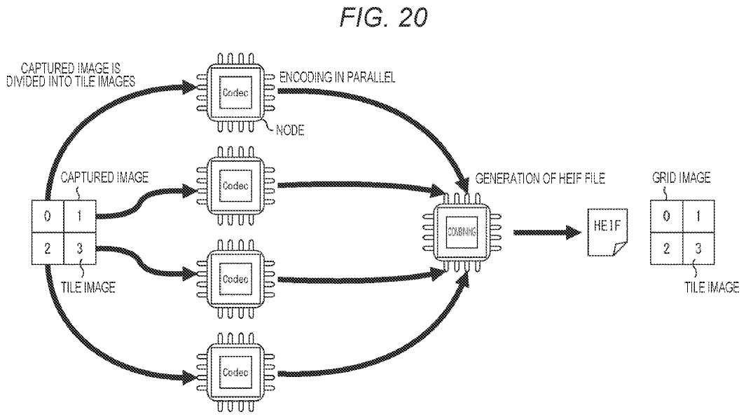

FIG. 20 is a diagram illustrating an example of setting the image size of the tile images in the fourth use case.

FIG. 20 illustrates a case where, in a plurality of nodes as processing blocks that process the tile images, the tile images are encoded one per node in parallel to generate one file HEIF file within a predetermined time.

That is, in FIG. 20, for example, each node encodes each of four tile images obtained by dividing the image captured by the digital camera 10, and one HEIF file storing the tile images after the encoding is generated within a predetermined time.

The encoding of the tile images in the node and the generation of one HEIF file storing the tile images after the encoding may be performed by the digital camera 10 or may be performed outside the digital camera 10.

In FIG. 20, the total processing time required for encoding the tile images in each node and generating the HEIF file is affected by the performance (encoding throughput) of the node, and in order to keep the total processing time within a predetermined time, it is necessary to limit the image size and bit rate (data amount) of the tile images processed in the node according to the performance of the node.

Accordingly, regarding the image size or the bit rate of the tile images, a target image size or a target bit rate to be a target (limit) can be set according to the performance of the node such that the total processing time falls within a predetermined time. Then, according to the target image size or the target bit rate, for example, the image size of the tile images can be set such that the image size or the bit rate of the tile images is equal to or less than the target image size or the target bit rate.

The target image size or the target bit rate can be set according to information from the outside.

For example, in the digital camera 10, the target image size or the target bit rate can be set such that the total processing time falls within a predetermined time according to the performance of the node or a predetermined time input by the user's operation (according to the user's operation). In a case where the node is an external device external to the digital camera 10, the target image size or the target bit rate can be set such that the total processing time falls within a predetermined time according to the performance of the node as information obtained from the node as the external device.

Note that, in the digital camera 10, for example, the target image size or the target bit rate can be set according to one or more of the profile, level, and tier of the codec supported by the node as the external device so as not to violate the profile, level, and tier.

Furthermore, in the digital camera 10, according to the connection method of connecting to the node as the external device, for example, the communication standard which the digital camera 10 and the node conform to when communicating with each other, it is possible to set the target image size or the target bit rate so as not to violate the profile, level, and tier of the codec supported by the communication standard.

The image size of the tile images can be set such that the image size or the bit rate of the tile images is equal to or less than the target image size or the target bit rate, or such that the image size and the bit rate of the tile images respectively fall within predetermined ranges based on the target image size and the target bit rate.

Note that, in FIG. 20, the target image size or the target bit rate is set according to information from the outside such as the performance of the node, but the image size of the tile images can be set according to the information from the outside such as the performance of the node such that the total processing time falls within a predetermined time.

Furthermore, in FIG. 20, the tile images are obtained by dividing the image captured by the digital camera 10, but for example, a plurality of images captured by a plurality of cameras can be used as the tile images and input to the node.

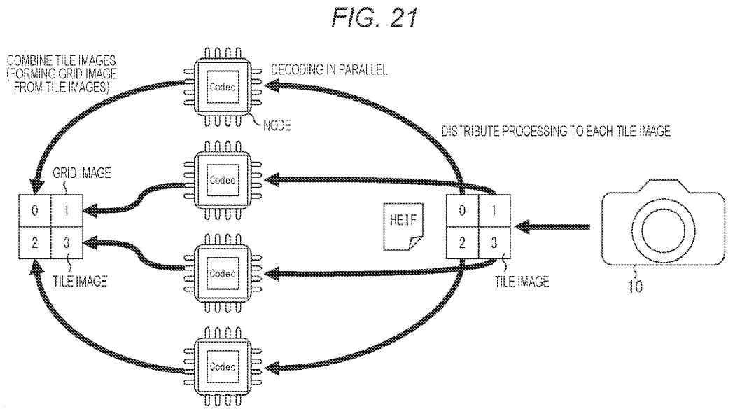

FIG. 21 is a diagram illustrating an example of setting the image size of the tile images in the fifth use case.

FIG. 21 illustrates a case where a plurality of tile images stored in the HEIF file is decoded in parallel in a plurality of nodes as processing blocks that process the tile images, and reproduction with a restriction on reproduction time per image, such as slide show reproduction, TimeLapse reproduction, or the like, is performed on the grid image formed by the plurality of tile images decoded in the plurality of nodes.

That is, in FIG. 21, for example, each node decodes each of four tile images obtained by dividing the image captured by the digital camera 10, and the grid image is including the four tile images within a predetermined time for satisfying the restriction of the reproduction time.

The decoding of the tile images at the nodes and the formation of the grid image in which the tile images are arranged may be performed in the digital camera 10 or may be performed outside the digital camera 10.

In FIG. 21, the total processing time required for decoding the tile images and forming the grid image in each node is affected by the performance (decoding throughput) of the node, and in order to keep the total processing time within a predetermined time, it is necessary to limit the image size and bit rate of the tile images processed in the node according to the performance of the node.

Accordingly, regarding the image size or the bit rate of the tile images, the target image size or the target bit rate as targets can be set according to the performance of the node such that the total processing time falls within a predetermined time. Then, the image size of the tile images can be set such that the image size or the bit rate of the tile images is equal to or less than the target image size or the target bit rate.

As in the case of FIG. 20, the target image size or the target bit rate can be set according to the information from the outside.

Note that, in FIG. 21, the target image size or the target bit rate is set according to the information from the outside such as the performance of the node, but the image size of the tile images can be set according to the information from the outside such as the performance of the node such that the total processing time falls within a predetermined time.

Furthermore, in FIG. 21, the tile images are obtained by dividing the image captured by the digital camera 10, but for example, as in the case of FIG. 20, a plurality of images captured by a plurality of cameras can be used as the tile images and input to the node.

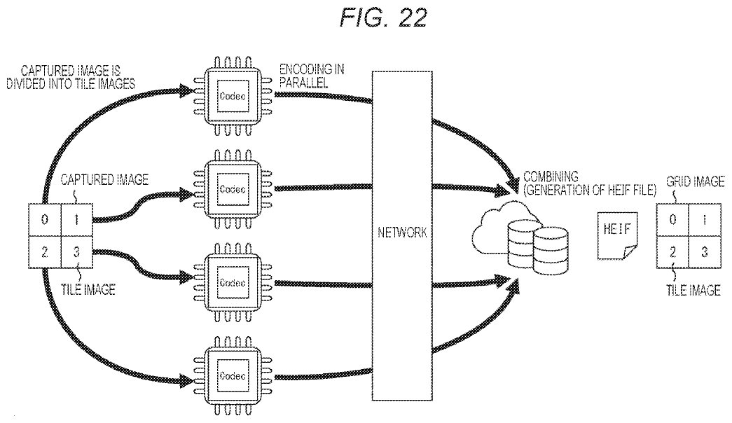

FIG. 22 is a diagram illustrating an example of setting the image size of the tile images in the sixth use case.

FIG. 22 illustrates a case where, in a plurality of nodes as processing blocks that process the tile images, encoding and transferring the tile images one per node in parallel and generating the HEIF file storing the tile images at a transfer destination are performed within a predetermined time (completed).

That is, in FIG. 22, for example, encoding and transferring, by each node, each of four tile images obtained by dividing the image captured by the digital camera 10 and generating one HEIF file storing the tile images after the encoding at a transfer destination are performed within a predetermined time.

The encoding of the tile images at the nodes may be performed by the digital camera 10 or may be performed outside the digital camera 10.

In FIG. 22, the total processing time required for the encoding of the tile images, the transfer of the tile images, and the generation of the HEIF file in each node is affected by the transfer band that can be used for the transfer of the tile images in the network used for the transfer of the tile images. Therefore, in order to keep the total processing time within a predetermined time, it is necessary to limit the image size and bit rate of the tile images processed by the node according to the transfer band of the network.

Accordingly, regarding the image size or the bit rate of the tile images, the target image size or the target bit rate as targets can be set according to the transfer band of the network such that the total processing time falls within a predetermined time. Then, the image size of the tile images can be set such that the image size or the bit rate of the tile images is equal to or less than the target image size or the target bit rate.

The target image size or the target bit rate can be set according to the information from the outside.

For example, in the digital camera 10, the target image size or the target bit rate can be set such that the total processing time falls within a predetermined time according to a predetermined time input by the user's operation or a transfer band of the network (according to the user's operation). Furthermore, in a case where the transfer band can be obtained from an external network, the digital camera 10 can set the target image size or the target bit rate such that the total processing time falls within the predetermined time according to the transfer band obtained from the network.

Note that, in FIG. 22, the target image size or the target bit rate is set according to the information from the outside such as the bandwidth of the network, but the image size of the tile images can be set according to the information from the outside such as the bandwidth of the network such that the total processing time falls within a predetermined time.

Furthermore, in FIG. 22, the tile images are obtained by dividing the image captured by the digital camera 10, but for example, a plurality of images captured by a plurality of cameras can be used as the tile images and input to the node.

As above, as described in FIG. 13, the image size of the tile images can be statically set by rewriting the firmware of the digital camera 10 into new firmware as the information from the outside according to the reproduction environment of the world.

Furthermore, the image size of the tile images can be dynamically set as described in FIGS. 14, 15, and 20 to 22.

For example, the image size of the tile images can be dynamically set according to the information from the outside, for example, the user's operation or information from the external device such as a cloud.

Furthermore, the image size of the tile images can be dynamically set according to performance (throughput of encoding and decoding, profile, level, and tear of the supported codec, and the like) of the node or the like as the external device connected to the digital camera 10, the communication standard (connection standard) as the connection method between the digital camera 10 and the external device, the transfer band (communication status) of a network used when the tile images are transferred, and the like.

Moreover, the image size of the tile images can be dynamically set according to a configuration of a system that processes the tile images, such as a system that encodes the tile images (encoding system) or a system that decodes the tile images (decoding system).

In a case where a configuration in which a plurality of tile images obtained by dividing the image captured by one digital camera 10 is encoded by a plurality of nodes is employed as a configuration of a system for processing the tile images, for example, as illustrated in FIG. 20, the image size of the tile images can be dynamically set according to the performance of the nodes.

For example, as illustrated in FIG. 15, in a case where a configuration for processing the HEIF file storing the tile images generated by each of the plurality of cameras is employed as the configuration of the system for processing the tile images, the image size of the tile images can be dynamically set according to the performance of the plurality of cameras that generates the HEIF file storing the tile images, for example, the profile of the codec supported by the plurality of cameras, or the like.

In a case where a configuration in which the tile images are decoded by nodes is employed as the configuration of the system for processing the tile images, for example, as illustrated in FIG. 21, the image size of the tile images can be dynamically set according to the performance (restriction) of hardware and software constituting the nodes, for example, the profile of the codec supported by the nodes, or the like.

<Configuration Example of Encoding Control Unit 42>

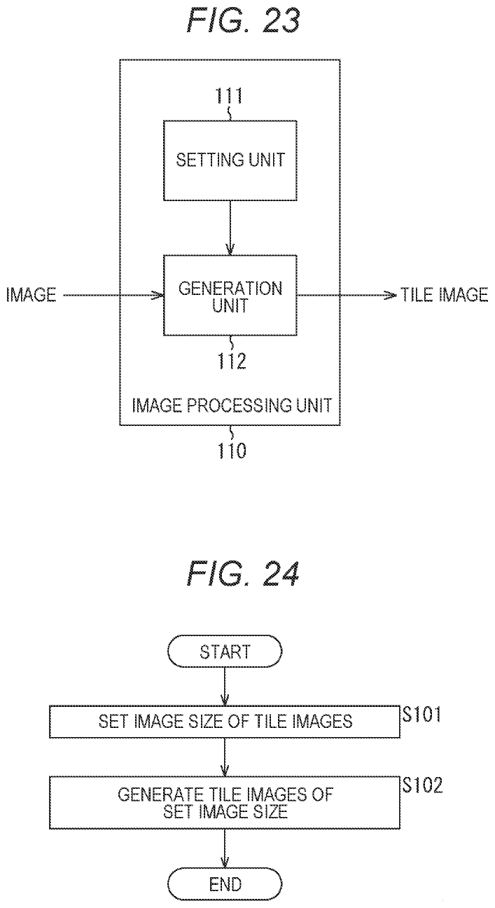

FIG. 23 is a block diagram illustrating a configuration example of the encoding control unit 42.

Note that FIG. 23 illustrates only an image processing unit 110 that is a portion of the encoding control unit 42 that generates the tile images.

The image processing unit 110 includes a setting unit 111 and a generation unit 112.

The setting unit 111 sets the image size of the tile images according to the target image size or the target bit rate of the tile images, for example, such that the image size or the bit rate of the tile images is equal to or less than the target image size or the target bit rate, or such that the image size or the bit rate of the tile images falls within a predetermined range with respect to the target image size or the target bit rate, and supplies the image size of the tile images to the generation unit 112. Alternatively, the setting unit 111 sets the image size of the tile images according to the information from the outside, and supplies the image size to the generation unit 112.

The generation unit 112 generates the tile images of the image size (set image size) from the setting unit 111 by dividing the image supplied from the optical system/image sensor control unit 41 to the encoding control unit 42.

FIG. 24 is a flowchart illustrating an example of processing of the image processing unit 110.

In step S101, the setting unit 111 sets the image size of the tile images according to one or both of the target image size and the target bit rate of the tile images. Alternatively, the setting unit 111 sets the image size of the tile images according to the information from the outside. Then, the setting unit 111 supplies the image size (set image size) of the tile images to the generation unit 112, and the processing proceeds from step S101 to step S102.

In step S102, the generation unit 112 generates the tile images of the image size from the setting unit 111 by dividing the image supplied from the optical system/image sensor control unit 41 to the encoding control unit 42, and the processing ends.

Thereafter, the tile images generated by the generation unit 112 are encoded by the encoding control unit 42, and the HEIF file storing the tile images after the encoding are generated by the file control unit 43.

As described above, since the image size of the tile images is set according to one or both of the target image size and the target bit rate of the tile images or according to the information from the outside, the tile images of an appropriate image size can be obtained.

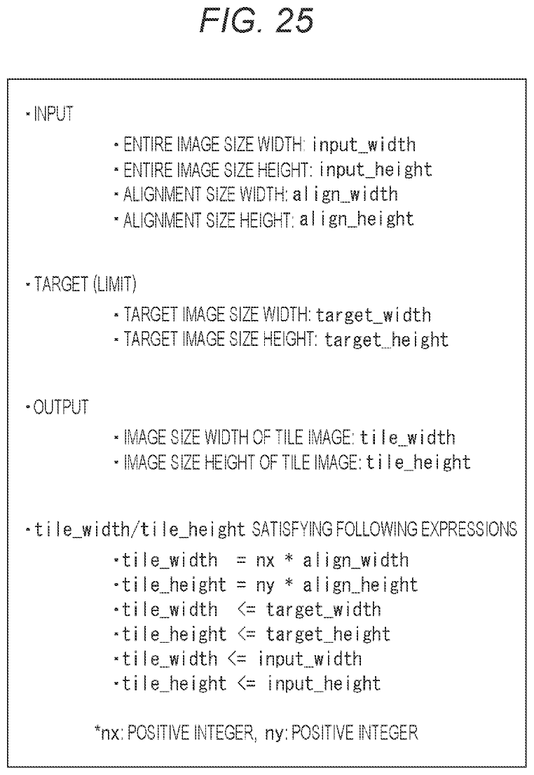

FIG. 25 is a diagram illustrating an example of an image size setting method of setting the image size of the tile images such that the image size of the tile images is equal to or smaller than the target image size.

In FIG. 25, the entire image size width input_width represents the number of horizontal pixels of a captured image that is captured by the digital camera 10 and is prior to dividing into the tile images, and the entire image size height input_height represents the number of vertical pixels of the captured image.

An alignment size width align_width and an alignment size height align_height represent a predetermined number of pixels (hereinafter also referred to as the number of aligned pixels) in a case where an image size of an image to be processed is required to be a multiple of a predetermined number of pixels in the codec that encodes/decodes the tile images. The alignment size width align_width represents the number of alignment pixels with respect to the number of pixels in the horizontal direction, and the alignment size height align_height represents the number of alignment pixels with respect to the number of pixels in the vertical direction.

The target image size width target_width and the target image size height target_height represent the respective target numbers of horizontal and vertical pixels (target image size) of the tile images.

An image size width tile_width and an image size height tile_height of the tile images represent the respective numbers of horizontal and vertical pixels of the tile images.

The entire image size width input_width and the entire image size height input_height, and the alignment size width align_width and the alignment size height align_height are supplied to the setting unit 111 as inputs.

In the digital camera 10, the entire image size width input_width and the entire image size height input_height can be set according to, for example, the user's operation or the like. For example, a plurality of sets is prepared as sets of the entire image size width input_width and the entire image size height input_height, and a set according to the user's operation is selected from the plurality of sets, and can be set as the entire image size width input_width and the entire image size height input_height. In addition, the entire image size width input_width and the entire image size height input_height can be set according to an instruction (information) from the outside such as a cloud, for example. The digital camera 10 captures a captured image having an image size represented by the entire image size width input_width and the entire image size height input_height.

The alignment size width align_width and the alignment size height align_height can be set according to the codec employed by the encoding control unit 42 for encoding and decoding the tile images. In addition, the alignment size width align_width and the alignment size height align_height can be set similarly to the entire image size width input_width and the entire image size height input_height, for example.

In a case where the entire image size width input_width and the entire image size height input_height, and the alignment size width align_width and the alignment size height align_height are set according to the user's operation, it can be said that the entire image size width input_width and the entire image size height input_height, and the alignment size width align_width and the alignment size height align_height are parameters set according to the user's operation in the digital camera 10.

The target image size width target_width and the target image size height target_height (target image size) can be set according to the user's operation, information from the outside such as information from the external device, and the like.

The setting unit 111 sets the image size width tile_width and the image size height tile_height (image size) of the tile images such that the number of pixels in the horizontal direction and the number of pixels in the vertical direction of the tile images are equal to or less than the target image size width target_width and the target image size height target_height, respectively, according to the entire image size width input_width and the entire image size height input_height, and the target image size width target_width and the target image size height target_height.

That is, the setting unit 111 obtains each of a maximum tile_width and a maximum tile_height that are integer multiples of the alignment size width align_width and the alignment size height align_height and satisfy Expression (1), and sets the maximum tile_width and the maximum tile_height to the image size width tile_width and the image size height tile_height of the tile images, respectively.

tile_width=nx*align_width

tile_height=ny*align_height

tile_width<=target_width

tile_height<=target_height

tile_width<=input_width

tile_height<=input_height (1)

nx and ny represent positive integers.

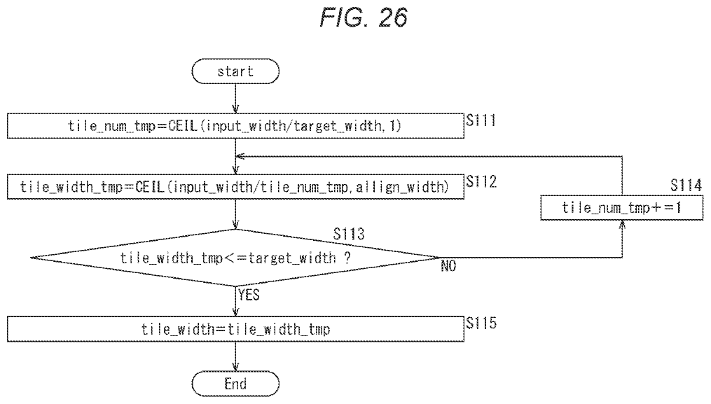

FIG. 26 is a flowchart illustrating an example of a process of setting the image size of the tile images such that the image size of the tile images is equal to or smaller than the target image size.

Note that, in FIG. 26, the processing of setting the image size of the tile images will be described focusing on the setting of the image size width tile_width out of the image size width tile_width and the image size height tile_height of the tile images, but the setting of the image size height tile_height is also performed similarly to the setting of the image size width tile_width.

In step S111, the setting unit 111 sets a variable tile_num_tmp indicating the number of tile images in the horizontal direction when the captured image is divided into the tile images to CEIL (input_width/target_width, 1), and the processing proceeds to step S112. A function CEIL (A, B) represents a minimum value of an integer of A or more among integer multiples of B.

In step S112, the setting unit 111 sets a variable tile_width_temp representing a candidate value of the image size width tile_width of the tile images to CEIL (input_width/tile_num_tmp, align_width), and the processing proceeds to step S113. Thus, in the variable tile_width_temp, a value that is an integral multiple of the alignment size width align_width is set as a candidate for the image size width tile_width of the tile images.

In step S113, the setting unit 111 determines whether the variable tile_width_temp is equal to or smaller than the target image size width target_width.

In a case where it is determined in step S113 that the variable tile_width_temp is not equal to or smaller than the target image size width target_width, the processing proceeds to step S114.

In step S114, the setting unit 111 increments the variable tile_num_tmp by 1 to thereby increase the number of tile images in the horizontal direction when the captured image is divided into the tile images by 1, and the processing returns to step S112 to repeat the similar processing.

Furthermore, in a case where it is determined in step S113 that the variable tile_width_temp is equal to or smaller than the target image size width target_width, the processing proceeds to step S115.

In step S115, the setting unit 111 sets the image size width tile_width to the variable tile_width_temp, and ends the processing.

Note that, in the above description of FIG. 26, the setting of the image size height tile_height will be described by replacing “width” with “height”.

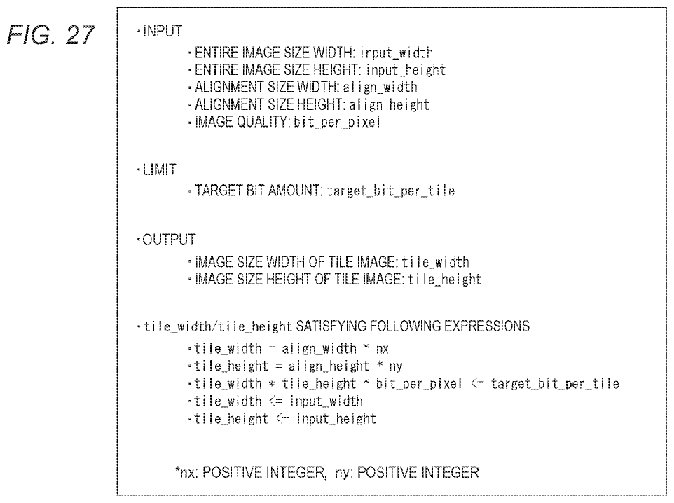

FIG. 27 is a diagram illustrating an example of an image size setting method of setting the image size of the tile images such that the bit rate of the tile images is equal to or less than the target bit rate.

In FIG. 27, as in the case of FIG. 25, the entire image size width input_width and the entire image size height input_height, and the alignment size width align_width and the alignment size height align_height are used to set the image size of the tile images.

Moreover, in FIG. 27, image quality bit_per_pixel is used to set the image size of the tile images, in addition to the entire image size width input_width and the entire image size height input_height, and the alignment size width align_width and the alignment size height align_height. The image quality bit_per_pixel represents a bit depth as the data amount (code amount) allocated per pixel of the tile images, and corresponds to (affects) the image quality of the tile images.

Furthermore, in FIG. 27, the target bit amount target_bit_per_tile as the target bit rate is used to set the image size of the tile images, instead of the target image size width target_width and the target image size height target_height described in FIG. 25. The target bit amount target_bit_per_tile as the target bit rate represents a target data amount (code amount) of the tile images.

The image quality bit_per_pixel is supplied to the setting unit 111 as an input.

The image quality bit_per_pixel can be set according to the user's operation or the like, for example, similarly to the entire image size width input_width and the entire image size height input_height in FIG. 25. In a case where the image quality bit_per_pixel is set according to the user's operation, it can be said that the image quality bit_per_pixel is a parameter set according to the user's operation in the digital camera 10.

The target bit amount target_bit_per_tile (target bit rate) can be set according to the user's operation, information from the outside such as information from the external device, and the like, for example, the transfer band of the network when the tile images are transferred via the network as described in FIG. 22.

The setting unit 111 sets the image size width tile_width and the image size height tile_height (image size) of the tile images such that the bit rate (data amount) tile_width*tile_height*bit_per_pixel of the tile images are equal to or less than the target bit amount target_bit_per_tile as the target bit rate according to the entire image size width input_width and the entire image size height input_height, the image quality bit_per_pixel, and the target bit amount target_bit_per_tile.

That is, the setting unit 111 obtains each of the maximum tile_width and the maximum tile_height that are integer multiples of the alignment size width align_width and the alignment size height align_height and satisfy Expression (2), and sets the maximum tile_width and the maximum tile_height to the image size width tile_width and the image size height tile_height of the tile images, respectively.

tile_width=align_width*nx

tile_height=align_height*ny

tile_width*tile_height*bit_per_pixel<=target_bit_per_tile

tile_width<=input_width

tile_height<=input_height (2)

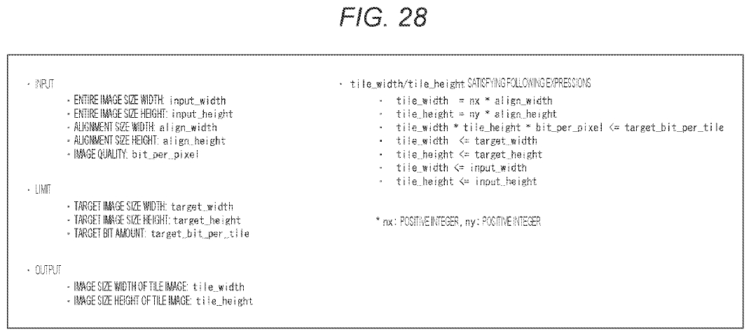

FIG. 28 is a diagram illustrating an example of an image size setting method of setting the image size of the tile images such that the image size and the bit rate of the tile images become equal to or less than the target image size and the target bit rate, respectively.

In FIG. 28, as in the case of FIG. 25, the entire image size width input_width and the entire image size height input_height, and the alignment size width align_width and the alignment size height align_height are used to set the image size of the tile images.

Moreover, in FIG. 28, the image quality bit_per_pixel described in FIG. 27 is used to set the image size of the tile images, in addition to the entire image size width input_width and the entire image size height input_height, and the alignment size width align_width and the alignment size height align_height.

Furthermore, in FIG. 28, the target image size width target_width and the target image size height target_height described in FIG. 25 and the target bit amount target_bit_per_tile as the target bit rate described in FIG. 27 are used to set the image size of the tile images.

The setting unit 111 sets the image size width tile_width and the image size height tile_height (image size) of the tile images such that the number of pixels in the horizontal direction and the number of pixels in the vertical direction of the tile images are equal to or less than the target image size width target_width and the target image size height target_height, respectively, and such that the bit rate (data amount) tile_width*tile_height*bit_per_pixel of the tile images is equal to or less than the target bit amount target_bit_per_tile as the target bit rate according to the entire image size width input_width and the entire image size height input_height, the target image size width target_width and the target image size height target_height, the image quality bit_per_pixel, and the target bit amount target_bit_per_tile.

That is, the setting unit 111 obtains each of the maximum tile_width and the maximum tile_height that are integer multiples of the alignment size width align_width and the alignment size height align_height and satisfy Expression (3), and sets the maximum tile_width and the maximum tile_height to the image size width tile_width and the image size height tile_height of the tile images, respectively.

tile_width=nx*align_width

tile_height=ny*align_height

tile_width*tile_height*bit_per_pixel<=target_bit_per_tile

tile_width<=target_width

tile_height<=target_height

tile_width<=input_width

tile_height<=input_height (3)

Note that the target image size width target_width and the target image size height target_height, and the target bit amount target_bit_per_tile as the target bit rate may be limited depending on the profile, level, and tier of the codec supported by the node or the like. In a case where the target image size width target_width and the target image size height target_height, and the target bit amount target_bit_per_tile as the target bit rate are limited to predetermined values by the profile of the codec or the like, the image size width tile_width and the image size height tile_height of the tile images are set in accordance with Expression (3) according to the target image size width target_width and the target image size height target_height limited to the predetermined values, and the target bit amount target_bit_per_tile as the target bit rate.

<Description of Computer To Which Present Technology Is Applied>

Next, the series of processes described above can be performed by hardware or software. In a case where the series of processing is performed by software, a program constituting the software is installed in a general-purpose computer or the like.

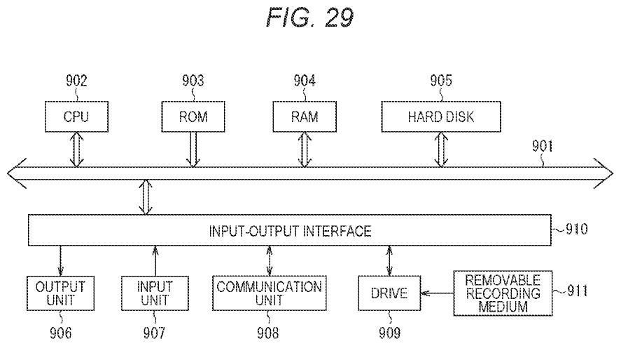

FIG. 29 is a block diagram illustrating a configuration example of an embodiment of the computer on which the program for executing the above-described series of processing is installed.

The program can be pre-recorded on a hard disk 905 or ROM 903 as a recording medium incorporated in the computer.

Alternatively, the program can be stored (recorded) in a removable recording medium 911 driven by a drive 909. Such a removable recording medium 911 can be provided as what is called package software. Here, examples of the removable recording medium 911 include, for example, a flexible disk, a compact disc read only memory (CD-ROM), a magneto optical (MO) disk, a digital versatile disc (DVD), a magnetic disk, a semiconductor memory, and the like.

Note that in addition to installing the program on the computer from the removable recording medium 911 as described above, the program can be downloaded to the computer via a communication network or a broadcasting network and installed on the incorporated hard disk 905. That is, for example, the program can be transferred to the computer wirelessly from a download site via an artificial satellite for digital satellite broadcasting, or transferred to the computer by wire via a network such as a local area network (LAN) or the Internet.

The computer has an incorporated central processing unit (CPU) 902, and an input-output interface 910 is connected to the CPU 902 via a bus 901.

If a command is input by a user through the input-output interface 910 by operating an input unit 907 or the like, the CPU 902 executes the program stored in the read only memory (ROM) 903 accordingly. Alternatively, the CPU 902 loads the program stored in the hard disk 905 into a random access memory (RAM) 904 and executes the program.

Thus, the CPU 902 performs the processing according to the above-described flowchart or the processing performed according to the above-described configuration of the block diagram. Then, the CPU 902 outputs a processing result thereof from an output unit 906 or sends the processing result from a communication unit 908 if necessary via the input-output interface 910 for example, and further causes recording of the processing result on the hard disk 905, or the like.

Note that the input unit 907 includes a keyboard, a mouse, a microphone, and the like. Furthermore, the output unit 906 includes a liquid crystal display (LCD), a speaker, and the like.

Here, in the present description, the processing performed by the computer according to the program does not necessarily have to be performed in time series in the order described as the flowchart. That is, the processing performed by the computer according to the program also includes processing that is executed in parallel or individually (for example, parallel processing or object processing).

Furthermore, the program may be processed by one computer (processor) or may be processed in a distributed manner by a plurality of computers. Moreover, the program may be transferred to a distant computer and executed.

Moreover, in the present description, a system means a set of a plurality of components (devices, modules (parts), and the like), and it does not matter whether or not all components are in the same housing. Therefore, both of a plurality of devices housed in separate housings and connected via a network and a single device in which a plurality of modules is housed in one housing are systems.

Note that the embodiments of the present technology are not limited to the above-described embodiments, and various modifications are possible without departing from the gist of the present technology.

For example, the present technology can employ a configuration of cloud computing in which one function is shared by a plurality of devices via a network and processed jointly.

Furthermore, each step described in the above-described flowcharts can be executed by one device, or can be executed in a shared manner by a plurality of devices.

Moreover, in a case where a plurality of processes is included in one step, the plurality of processes included in the one step can be executed in a shared manner by a plurality of devices in addition to being executed by one device.

Furthermore, the effects described in the present description are merely examples and are not limited, and other effects may be provided.

Note that the present technology can have the following configurations.

<1>

An image processing device including
an image processing unit that sets an image size of tile images, which form a grid image and are stored in a high efficiency image file format (HEIF) file, according to a target image size or a target bit rate of the tile images, and generates the tile images of the image size.

<2>

The image processing device according to <1>, in which
the image processing unit sets the image size of the tile images in such a manner that the image size or a bit rate of the tile images is equal to or less than a target image size or a target bit rate.

<3>

The image processing device according to <1> or <2>, in which
the image processing unit sets the image size of the tile images according to a parameter set according to an operation of a user.

<4>

The image processing device according to <1> or <2>, in which
the image processing unit sets the image size of the tile images according to an image size of the grid image set according to an operation of the user.

<5>

The image processing device according to <3>, in which
the image processing unit sets the image size of the tile images according to image quality of the tile images set according to an operation of the user.

<6>

The image processing device according to any one of <1> to <5>, in which
the image processing unit sets the target image size or the target bit rate according to information from an outside.

<7>

The image processing device according to <6>, in which
the image processing unit sets the target image size or the target bit rate according to an operation of the user.

<8>

The image processing device according to <6>, in which
the image processing unit sets the target image size or the target bit rate according to information from an external device.

<9>

The image processing device according to <8>, in which
the image processing unit sets the target image size or the target bit rate according to one or more of a profile, a level, and a tier of a codec supported by the external device.

<10>

The image processing device according to <8>, in which
the image processing unit sets the target image size or the target bit rate according to a connection method with the external device.

<11>

The image processing device according to <8>, in which
the image processing unit sets the target image size or the target bit rate according to performance of the external device.

<12>

The image processing device according to any one of <1> to <11>, in which
the image processing unit sets the image size of the tile images according to the target image size and the target bit rate.

<13>

An image processing method including
setting an image size of tile images, which form a grid image and are stored in a high efficiency image file format (HEIF) file, according to a target image size or a target bit rate of the tile images, and generating the tile images of the image size.

<14>

An image processing device including
an image processing unit that sets an image size of tile images, which form a grid image and are stored in a high efficiency image file format (HEIF) file, according to information from an outside, and generates the tile images of the image size.

<15>

The image processing device according to <14>, in which
the image processing unit sets the image size of the tile images according to an operation of a user.

<16>

The image processing device according to <14>, in which
the image processing unit sets the image size of the tile images according to information from an external device.

<17>

The image processing device according to <16>, in which
the image processing unit sets the image size of the tile images according to one or more of a profile, a level, and a tier of a codec supported by the external device.

<18>

The image processing device according to <16>, in which
the image processing unit sets the image size of the tile images according to a connection method with the external device.

<19>

The image processing device according to <16>, in which
the image processing unit sets the image size of the tile images according to performance of the external device.

<20>

An image processing method including
setting an image size of tile images, which form a grid image and are stored in a high efficiency image file format (HEIF) file, according to information from an outside, and generating the tile images of the image size.

### REFERENCE SIGNS LIST

10 Digital camera
11 Optical system
13 Signal processing unit
14 Medium
15, 16 I/F
17 Button/key
18 Touch panel
19 Liquid crystal panel
20 View finder
21 I/F
41 Optical system/image sensor control unit
42 Encoding control unit
43 File control unit
44 Medium control unit
45 Operation control unit
46 Display control unit
47 UI control unit
110 Image processing unit
111 Setting unit
112 Generation unit
901 Bus
902 CPU
903 ROM
904 RAM
905 Hard disk
906 Output unit
907 Input unit
908 Communication unit
909 Drive
910 Input-output interface
911 Removable recording medium

1. An image processing device comprising
an image processing unit that sets an image size of tile images, which form a grid image and are stored in a high efficiency image file format (HEIF) file, according to a target image size or a target bit rate of the tile images, and generates the tile images of the image size.

2. The image processing device according to claim 1, wherein
the image processing unit sets the image size of the tile images in such a manner that the image size or a bit rate of the tile images is equal to or less than a target image size or a target bit rate.

3. The image processing device according to claim 1, wherein
the image processing unit sets the image size of the tile images according to a parameter set according to an operation of a user.

4. The image processing device according to claim 3, wherein
the image processing unit sets the image size of the tile images according to an image size of the grid image set according to an operation of the user.

5. The image processing device according to claim 3, wherein
the image processing unit sets the image size of the tile images according to image quality of the tile images set according to an operation of the user.

6. The image processing device according to claim 1, wherein
the image processing unit sets the target image size or the target bit rate according to information from an outside.

7. The image processing device according to claim 6, wherein
the image processing unit sets the target image size or the target bit rate according to an operation of the user.

8. The image processing device according to claim 6, wherein
the image processing unit sets the target image size or the target bit rate according to information from an external device.

9. The image processing device according to claim 8, wherein
the image processing unit sets the target image size or the target bit rate according to one or more of a profile, a level, and a tier of a codec supported by the external device.

10. The image processing device according to claim 8, wherein
the image processing unit sets the target image size or the target bit rate according to a connection method with the external device.

11. The image processing device according to claim 8, wherein
the image processing unit sets the target image size or the target bit rate according to performance of the external device.

12. The image processing device according to claim 1, wherein
the image processing unit sets the image size of the tile images according to the target image size and the target bit rate.

13. An image processing method comprising
setting an image size of tile images, which form a grid image and are stored in a high efficiency image file format (HEIF) file, according to a target image size or a target bit rate of the tile images, and generating the tile images of the image size.

14. An image processing device comprising
an image processing unit that sets an image size of tile images, which form a grid image and are stored in a high efficiency image file format (HEIF) file, according to information from an outside, and generates the tile images of the image size.

15. The image processing device according to claim 14, wherein
the image processing unit sets the image size of the tile images according to an operation of a user.

16. The image processing device according to claim 14, wherein
the image processing unit sets the image size of the tile images according to information from an external device.

17. The image processing device according to claim 16, wherein
the image processing unit sets the image size of the tile images according to one or more of a profile, a level, and a tier of a codec supported by the external device.

18. The image processing device according to claim 16, wherein
the image processing unit sets the image size of the tile images according to a connection method with the external device.

19. The image processing device according to claim 16, wherein
the image processing unit sets the image size of the tile images according to performance of the external device.

20. An image processing method comprising
setting an image size of tile images, which form a grid image and are stored in a high efficiency image file format (HEIF) file, according to information from an outside, and generating the tile images of the image size.
